(19) United States
(12) Patent Application Publication
(10) Pub. No.: US 2012/0110784 A1
(43) Pub. Date: May 10, 2012

(54) PORTABLE DEVICE AND HINGE WITH A FLEXIBLE TUBE

(76) Inventors: Chia-Hao HSU, Shulin City (TW); Kuan-Chih CHEN, Shulin City (TW); Chia-Chun YUAN, Shulin City (TW); Che-Yu CHOU, Shulin City (TW)

(21) Appl. No.: 12/943,721

(22) Filed: Nov. 10, 2010

(51) Int. Cl. E05D 1/00; E05D 7/00

(52) U.S. Cl. 16/226; 16/225

(57) ABSTRACT

A hinge is mounted in a portable device with two panels and has a flexible tube and a linking unit. The linking unit receives the flexible tube and is attached to the panels of the portable device. Since the flexible tube does not restrict the rotating angle, the panels can stay at any desired visual angle and are pivoted steplessly.

### BACKGROUND OF THE INVENTION

1. Field of the Invention

The present invention relates to a portable device and a hinge, especially to a hinge with a flexible tube mounted between a cover and a base of a portable device.

2. Description of the Prior Arts

As technology advances, people depend more and more on portable devices such as notebook computers, mobile phones and the like. Thus, consumers also require the portable devices to be more convenient for use. The conventional portable device has a conventional hinge to allow the cover to pivot relative to the base. However, the rotating angle of the cover is limited by the structure of the conventional hinge. Therefore, the cover cannot be pivoted to any desired visual angle.

To overcome the shortcomings, the present invention provides a portable device and a hinge with a flexible tube to mitigate or obviate the aforementioned problems.

### SUMMARY OF THE INVENTION

The main objective of the present invention is to provide a hinge with flexible tubes. The hinge is mounted in a portable device and has a flexible tube and a linking unit. The linking unit receives the flexible tube and is attached to panels of the portable device. Since the flexible tube does not restrict the rotating angle, the panels can stay at any desired visual angle and are pivoted steplessly.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a first embodiment of a portable device;

FIG. 2 is a perspective view of a flexible tube of a hinge in accordance with the present invention;

FIG. 3 is an enlarged side view in partial section of the flexible tube in FIG. 2;

FIG. 4 is an operational side view of the flexible tube in FIG. 2, shown bent;

FIG. 5 is an exploded perspective view of a first embodiment of a hinge in accordance with the present invention;

FIG. 6 is an enlarged side view in partial section of the portable device in FIG. 1;

FIG. 7 is an operational perspective view of the portable device in FIG. 1, shown closed;

FIG. 8 is an operational side view of the portable device in FIG. 1, shown closed;

FIG. 9 is an operational perspective view of the portable device in FIG. 1, shown opened at 180 degrees;

FIG. 10 is an operational side view of the portable device in FIG. 1, shown opened at 180 degrees;

FIG. 11 is an operational perspective view of the portable device in FIG. 1, shown opened at 360 degrees;

FIG. 12 is an operational side view of the portable device in FIG. 1, shown opened at 360 degrees;

FIG. 13 is an operational perspective view of a second embodiment of a portable device in accordance with the present invention, shown opened at 180 degrees;

FIG. 14 is an exploded perspective view of a third embodiment of a portable device in accordance with the present invention;

FIG. 15 is an operational perspective view of the portable device in FIG. 14, shown closed;

FIG. 16 is an operational perspective view of the portable device in FIG. 14, shown opened at 180 degrees; and

FIG. 17 is an operational perspective view of the portable device in FIG. 14, shown opened at 360 degrees.

### DETAILED DESCRIPTION OF THE PREFERRED EMBODIMENTS

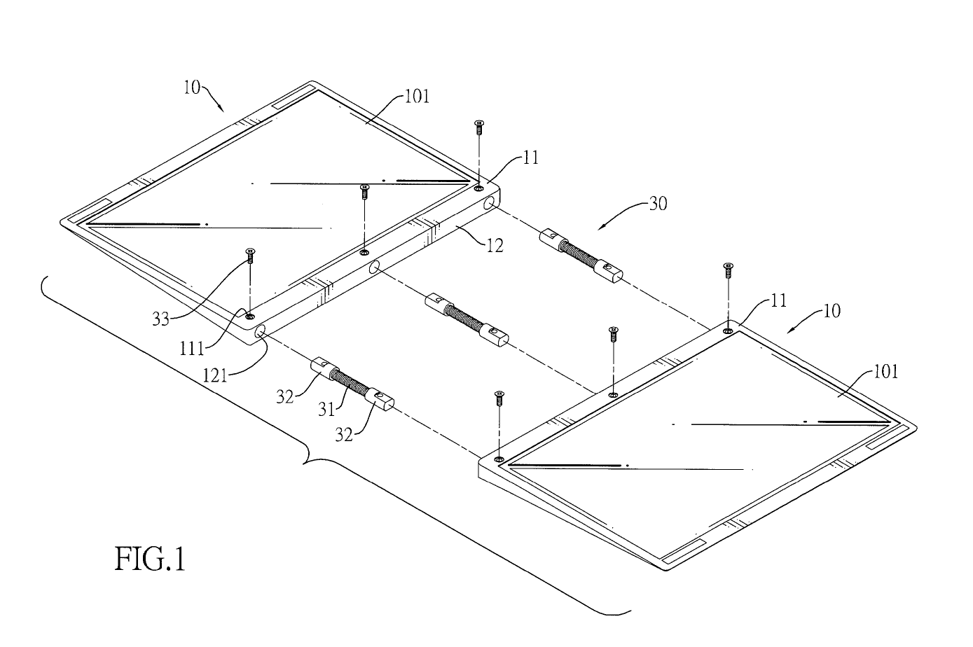

With reference to FIG. 1, a portable device in accordance with the present invention comprises two panels 10 and multiple hinges 30 in accordance with the present invention.

The panels 10 may respectively have an output device and an input device such as a display panel and a keyboard. For example, the output device is mounted on one panel 10 while the input device is mounted on the other panel 10. In another preferred embodiment, each panel 10 may have a touch panel 101 mounted thereon and can serve input and output functions simultaneously.

The hinges 30 are mounted between the panels 10. Each hinge 30 comprises a flexible tube 31 and a linking unit. The linking unit receives the flexible tube 31 and is respectively attached securely to the panels 10.

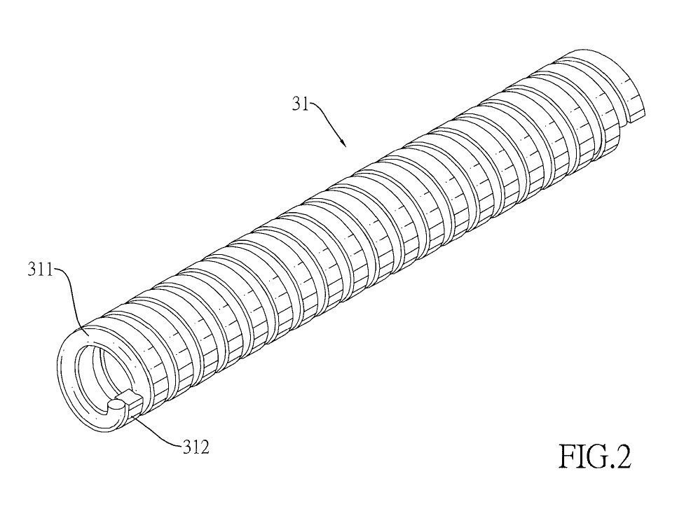

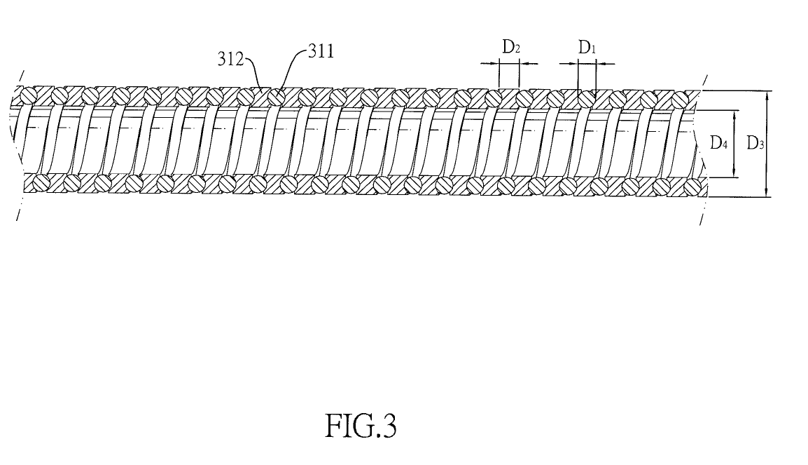

With reference to FIGS. 2 and 3, the flexible tube 31 comprises an inner spiral wire 311 and an outer spiral wire 312, and the outer spiral wires 312 twine upon the inner spiral wires 312. The inner and outer spiral wires 311, 312 are metal wires. In a preferred embodiment, the inner spiral wire 311 is made of high carbon steel and the outer spiral wire 312 is made of iron or copper. A diameter D₁ of the inner spiral wire 311 may be between 0.6 mm to 3.5 mm. A diameter D₂ of the outer spiral wire 312 may be between 0.5 mm to 2.2 mm. An outer diameter D₃ of the flexible tube 31 may be between 2.5 mm to 15 mm. An inner diameter D₄ of the inner spiral wire 311 may be between 1.2 mm to 7.3 mm. The lengths of the inner and outer diameters of the flexible tube 31 are determined by the weights of the panels 10. The preferred arrangement of D₁, D₂, D₃, and D₄ is shown in the following table.

| D1(mm) | D2(mm) | D3(mm) | D4(mm) |
|---|---|---|---|
| 0.6 | 0.50 | 2.5 | 1.2 |
| 0.7 | 0.60 | 4.1 | 2.5 |
| 0.8 | 0.60 | 3.0 | 1.2 |
| 0.8 | 0.60 | 3.5 | 1.6 |
| 0.8 | 0.60 | 3.6 | 1.8 |
| 0.9 | 0.70 | 3.6 | 1.4 |
| 0.8 | 0.60 | 3.9 | 2.1 |
| 1.0 | 0.80 | 4.0 | 1.5 |
| 1.0 | 0.70 | 4.0 | 1.8 |
| 1.0 | 0.80 | 4.0 | 1.9 |
| 0.9 | 0.70 | 4.0 | 2.0 |

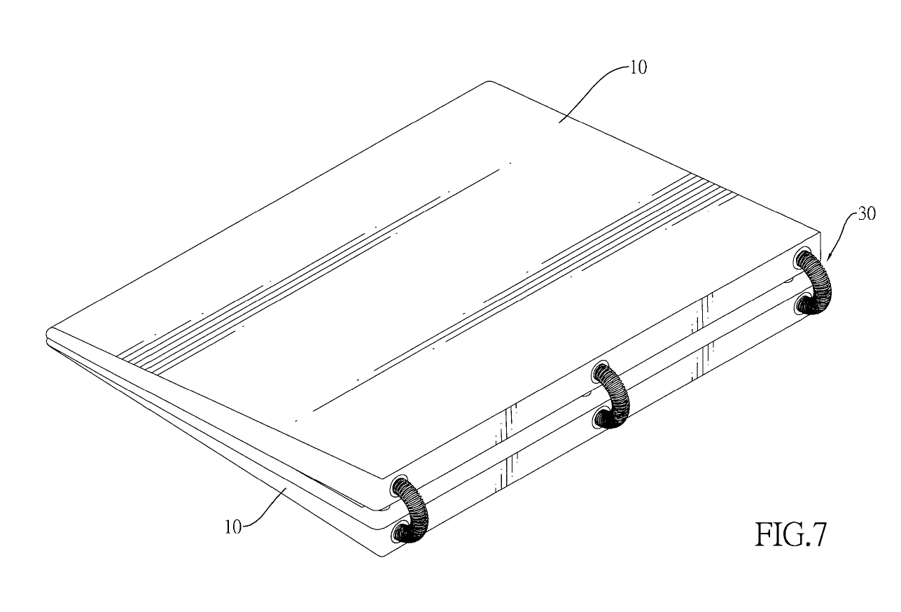

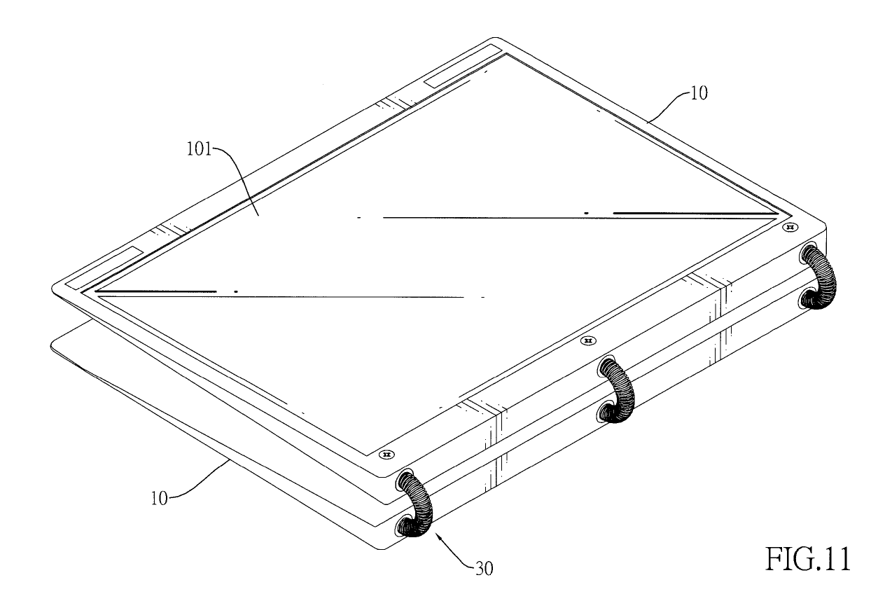

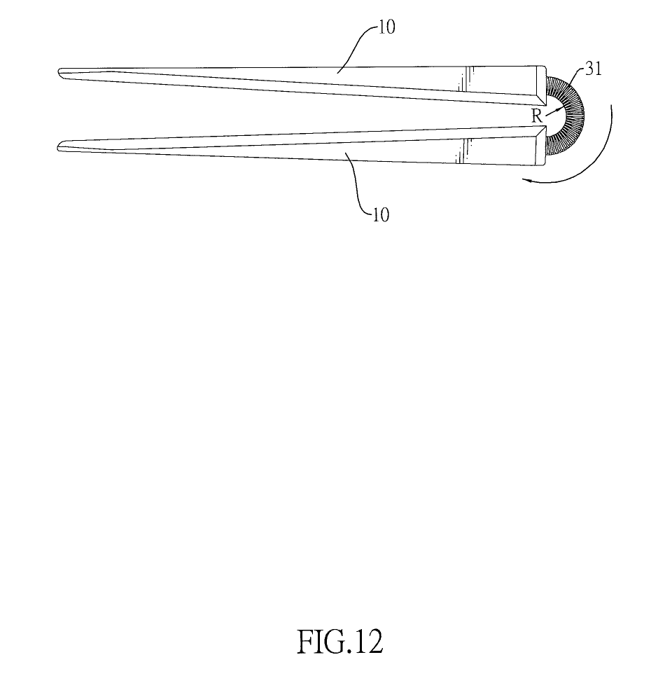

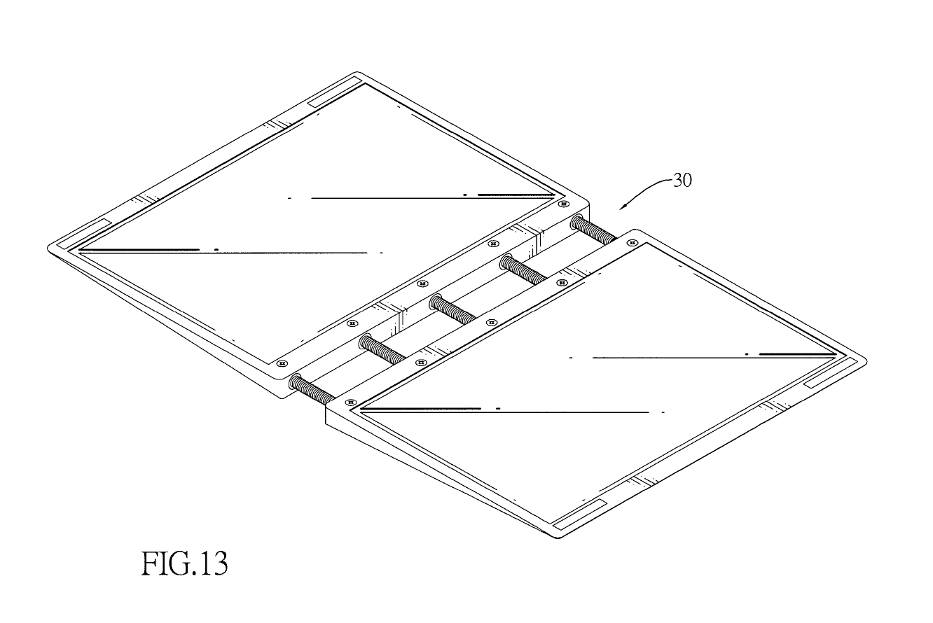

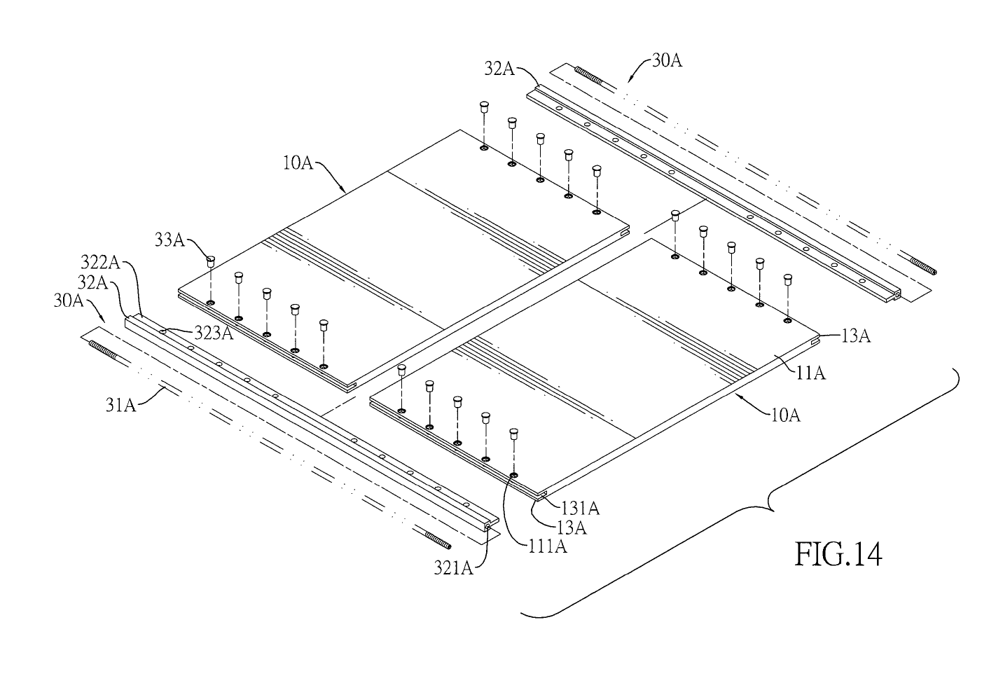

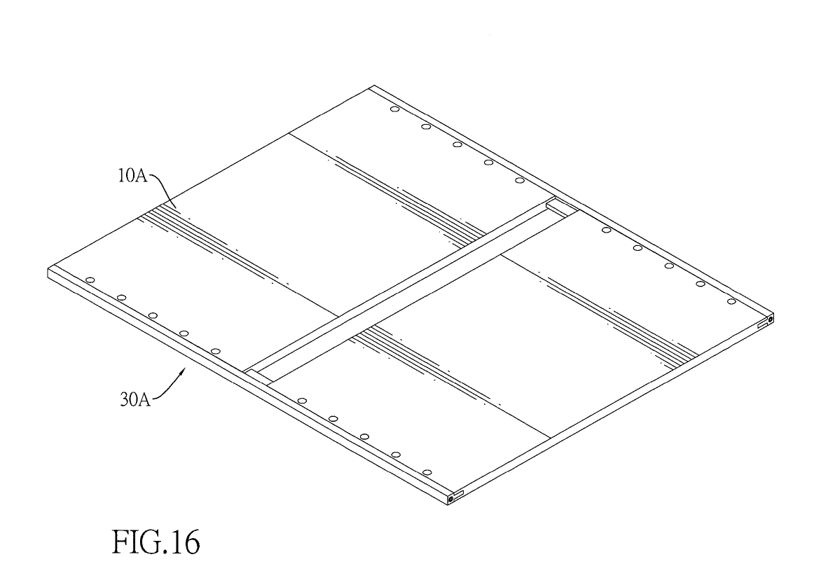

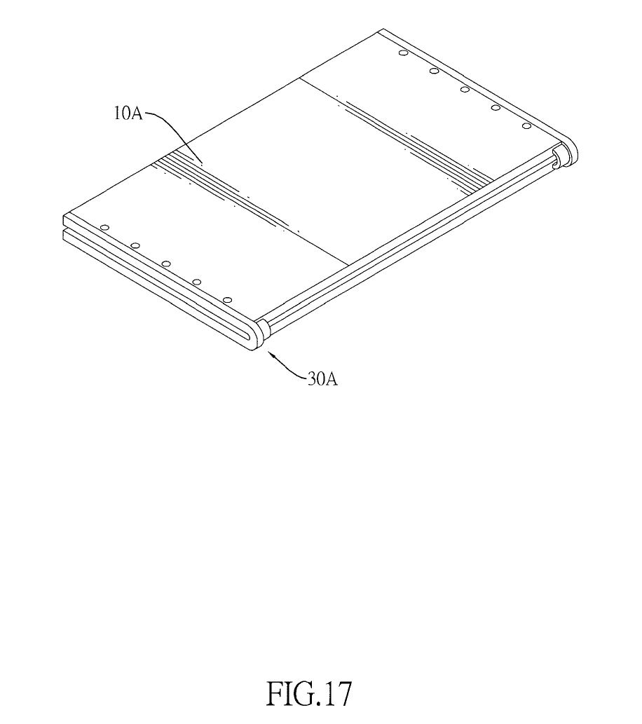

The number of the hinges 30 for the portable device as described is determined by the weights of the panels 10. In a preferred embodiment as shown in FIGS. 7 to 12, the portable device has three hinges 30. In another preferred embodiment as shown in FIG. 13, the portable device has five hinges 30. In still another preferred embodiment as shown in FIGS. 14 to 17, the portable device has two hinges 30A.

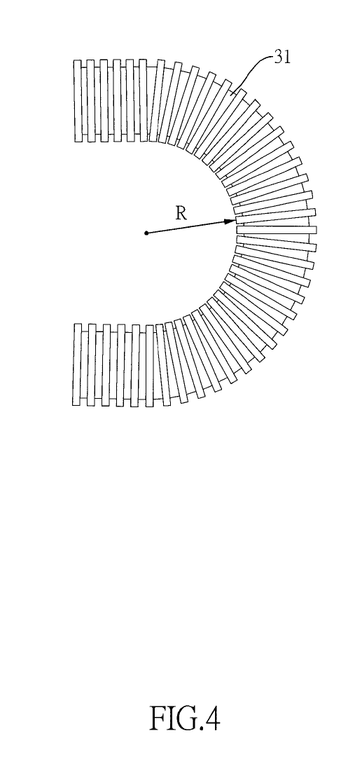

With reference to FIG. 4, a radius of curvature R is defined when the flexible tube 31 is bent to the largest degree of curve. In a preferred embodiment, the radius of curvature R is between 32 to 40 mm. The radius of curvature R is determined by the outer diameter D₃ of flexible tube 31. In a preferred embodiment, the radius of curvature R is 32 mm while the outer diameter D₃ of the flexible tube 31 is 3.6 mm. In another preferred embodiment, the radius of curvature R is 40 mm while the outer diameter D₃ of the flexible tube 31 is 4.0 mm. The outer diameter of the flexible tube 31 determines the strength of the flexible tube 31 for supporting the panels 10. Generally, the strength of the flexible tube 31 is greater when the outer diameter of the flexible tube 31 is larger. Then the panels 10 are easier to be positioned at any desired visual angle. When the outer diameter of the flexible tube 31 is larger, the radius of curvature of the flexible tube 31 is also larger. However, the larger the radius of curvature of the flexible tube 31 is, the more difficult the panels 10 are to be flush with each other when the portable device is closed. Therefore, multiple flexible tubes 31 are usually used to provide enough strength without adding to the radius of curvature of the flexible tube 31.

The hinges 30 can be connected to the panels 10 with different mechanisms. Two preferred embodiments are shown here as examples but do not limit the scope of the present invention.

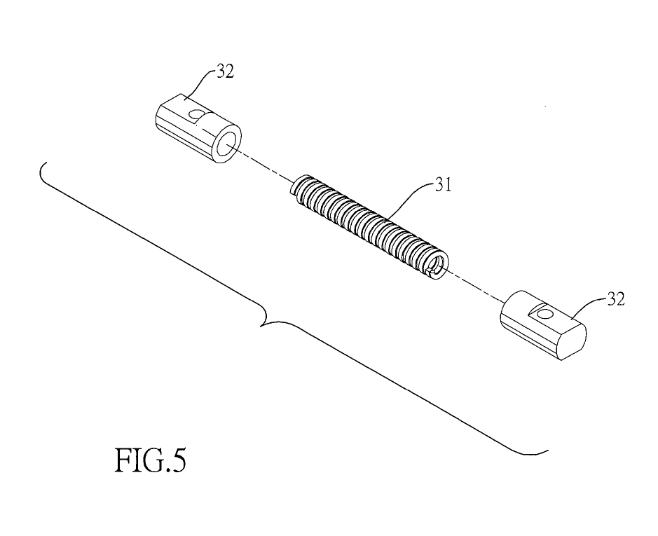

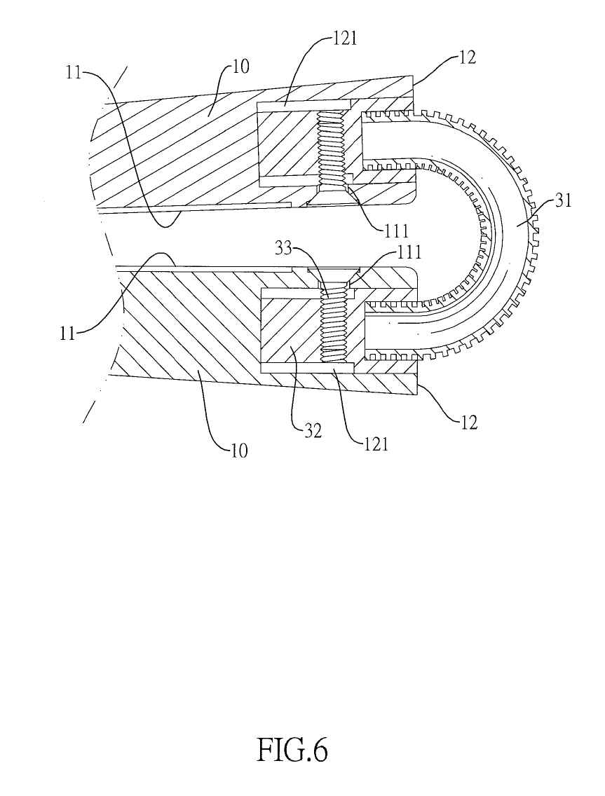

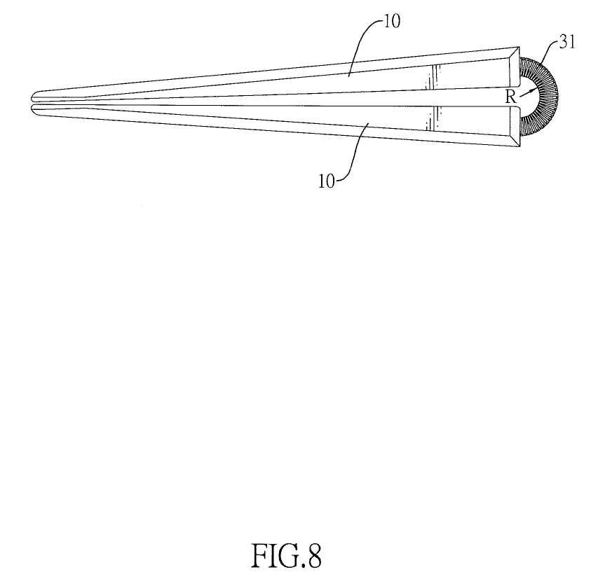

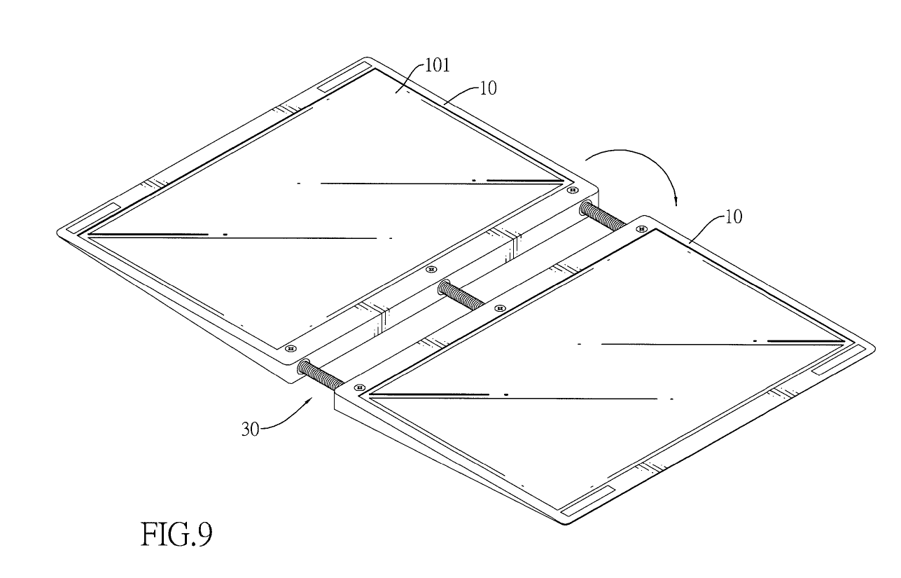

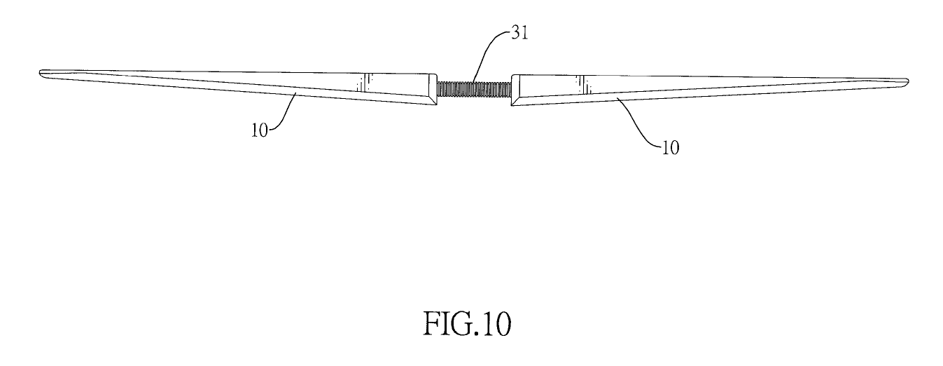

With reference to FIGS. 1, 5 and 6, each panel 10 has a working side 11, a pivoting side 12, multiple transverse fastening holes 111 and multiple longitudinal receiving holes 121. When the portable device is closed as shown in FIGS. 7 and 8, the working sides 11 of the panels 11 face each other. When the portable device is opened at 180 degrees as shown in FIGS. 9 and 10, the pivoting sides 12 of the panels 11 face each other. The transverse fastening holes 111 are formed separately on the working side 11 of each panel 10. The longitudinal receiving holes 121 are formed separately on the pivoting side 12 of each panel 10. Each longitudinal receiving hole 121 communicates with and corresponds to one transverse fastening hole 111. The linking unit of each hinge 30 comprises two sleeves 32 and two fasteners 33. The sleeves 32 are respectively mounted securely around two ends of the flexible tube 31. The sleeves 32 may be welded, adhered, or riveted at the end of the corresponding flexible tube 31. Each sleeve 32 is mounted through a corresponding longitudinal receiving hole 121 of a corresponding panel 10. Each fastener 33 is mounted through a corresponding transverse fastening hole 111 of a corresponding panel 10 and is mounted securely in a corresponding sleeve 32. Each fastener 33 may be a screw to be screwed into the threaded hole in the corresponding sleeve 32, or each fastener 33 may be a rivet to be riveted into the corresponding sleeve 32.

With reference to FIGS. 7 to 12, the panels 10 are pivoted steplessly to any desired visual angle since the flexible tubes 31 do not restrict the rotating angle. With the torque generated by the flexible tubes 31, the panels 10 are held at any desired visual angle. Furthermore, the flexible tubes 31 also allow the panels 10 to be opened relative to each other at 360 degrees so that it is easy for the user to click the touch panels 101 on any panels 10.

In another preferred embodiment as shown in FIG. 14, each panel 10A has two outer sides 13A parallel to each other. Each outer side 13A of one of the panels 10A aligns with one outer side 13A of the other one of the panels 10A when the portable device is opened at 180 degrees. Each outer side 13A has an elongated slot 131A and multiple transverse fastening holes 111A. The elongated slot 131A is formed on the outer side 13A. The transverse fastening holes 111 are formed separately on the outer side 13A and correspond to and communicate with the elongated slot 131A. The linking unit of each hinge 30A comprises a flexible bar 32A and multiple fasteners 33A. The flexible bar 32A is made of flexible materials such as rubber, silicon elastomer and the like. The flexible bar 32A has an elongated hole 321A, a rib 322A and multiple fastening holes 323A. The elongated hole 321A is formed longitudinally through the flexible bar 32A and receives the flexible tube 31A. The rib 322A is formed on a side of the flexible bar 32A and engages the elongated slots 131A that align with each other to connect the panels 10A. The fastening holes 323A are formed separately through the rib 322A. Each fastening hole 323A in the rib 322A aligns with one transverse fastening hole 111A in the panel 10A. Each fastener 33A is mounted through a corresponding transverse fastening hole 111A of a corresponding panel 10A and is mounted securely in a corresponding fastening hole 323A in the rib 322A. The foregoing way to connect the flexible bar 32A and the panels 10A is illustrative only and does not limit the scope of the present invention. The flexible bar 32A may be directly adhered to the panels 10A without forming the transverse fastening holes 111A and the fasteners 33A.

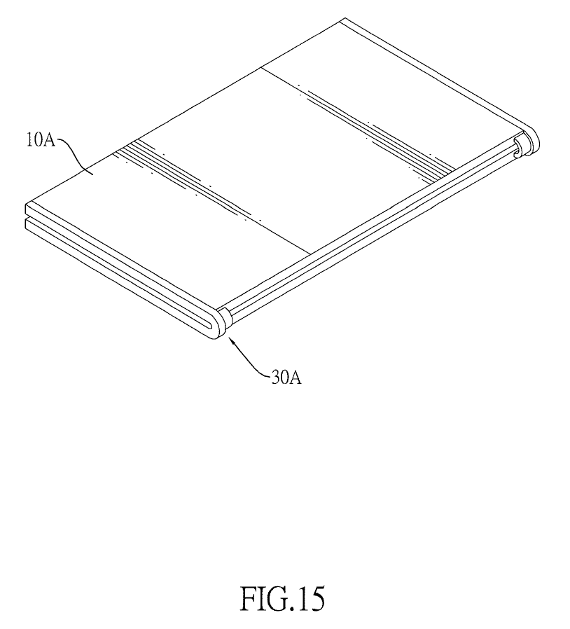

With further reference to FIGS. 15 to 17, the panels 10A are pivoted steplessly to any desired visual angle since the flexible tubes 31A do not restrict the rotating angle. With the torque generated by the flexible tubes 31A, the panels 10A are held at any desired visual angle. Furthermore, with the flexible bars 32A, the panels 10A may be flexible displays.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A hinge comprising:
a flexible tube; and
a linking unit receiving the flexible tube.

2. The hinge as claimed in claim 1, wherein the flexible tube comprises an inner spiral wire and an outer spiral wire with the outer spiral wire twined upon the inner spiral wire.

3. The hinge as claimed in claim 2, wherein
the inner spiral wire is made of high carbon steel; and
the outer spiral wire is made of iron.

4. The hinge as claimed in claim 1, wherein the linking unit comprises two sleeves respectively mounted securely around two ends of the flexible tube.

5. The hinge as claimed in claim 2, wherein the linking unit comprises two sleeves respectively mounted securely around two ends of the flexible tube.

6. The hinge as claimed in claim 3, wherein the linking unit comprises two sleeves respectively mounted securely around two ends of the flexible tube.

7. The hinge as claimed in claim 1, wherein the linking unit comprises a flexible bar having an elongated hole formed longitudinally therethrough and receiving the flexible tube.

8. The hinge as claimed in claim 2, wherein the linking unit comprises a flexible bar having an elongated hole formed longitudinally therethrough and receiving the flexible tube.

9. The hinge as claimed in claim 3, wherein the linking unit comprises a flexible bar having an elongated hole formed longitudinally therethrough and receiving the flexible tube.

10. The hinge as claimed in claim 2, wherein
a diameter of the inner spiral wire is between 0.6 mm and 3.5 mm;
a diameter of the outer spiral wire is between 0.5 mm to 2.2 mm;
an outer diameter of the flexible tube is between 2.5 mm to 15 mm;
an inner diameter of the flexible tube is between 1.2 mm to 7.3 mm.

11. The hinge as claimed in claim 2, wherein
a diameter of the inner spiral wire is between 0.6 mm and 1 mm;
a diameter of the outer spiral wire is between 0.5 mm to 0.8 mm;
an outer diameter of the flexible tube is between 2.5 mm to 4 mm;
an inner diameter of the flexible tube is between 1.2 mm to 2.5 mm.

12. A portable device with at least one hinge as claimed in claim 1, wherein the portable device comprises two panels, and the linking unit of the at least one hinge is respectively attached securely to the panels.

13. The portable device as claimed in claim 12 further comprising an output device mounted on one of the panels and an input device mounted on the other one of the panels.

14. The portable device as claimed in claim 12, wherein
each panel has
a working side, wherein when the portable device is closed, the working sides of the panels face each other;
a pivoting side, wherein when the portable device is opened at 180 degrees, the pivoting sides of the panels face each other;
multiple transverse fastening holes formed separately on the working side of each panel; and
multiple longitudinal receiving holes formed separately on the pivoting side of each panel, and each longitudinal receiving hole communicating with and corresponding to one transverse fastening hole; and
the linking unit of each one of the at least one hinge comprises
two sleeves respectively mounted securely around two ends of the flexible tube, and each sleeve mounted through a corresponding longitudinal receiving hole of a corresponding panel; and
two fasteners, and each fastener mounted through a corresponding transverse fastening hole of a corresponding panel and mounted securely in a corresponding sleeve.

15. The portable device as claimed in claim 13, wherein
each panel has
a working side, wherein when the portable device is closed, the working sides of the panels face each other;
a pivoting side, wherein when the portable device is opened at 180 degrees, the pivoting sides of the panels face each other;
multiple transverse fastening holes formed separately on the working side of each panel; and
multiple longitudinal receiving holes formed separately on the pivoting side of each panel, and each longitudinal receiving hole communicating with and corresponding to one transverse fastening hole; and
the linking unit of each one of the at least one hinge comprises
two sleeves respectively mounted securely around two ends of the flexible tube, and each sleeve mounted through a corresponding longitudinal receiving hole of a corresponding panel; and
two fasteners, and each fastener mounted through a corresponding transverse fastening hole of a corresponding panel and mounted securely in a corresponding sleeve.

16. The portable device as claimed in claim 12, wherein
each panel has
a working side, wherein when the portable device is closed, the working sides of the panels face each other; and
two outer sides parallel to each other wherein each outer side of one of the panels aligns with one outer side of the other one of the panels 10A when the portable device is opened at 180 degrees, and each outer side having
an elongated slot formed on the outer side; and
multiple transverse fastening holes formed separately on the outer side and corresponding to and communicating with the elongated slot; and
the linking unit of each one of the at least one hinge comprises
a flexible bar having
an elongated hole formed longitudinally through the flexible bar and receiving the flexible tube;
a rib formed on a side of the flexible bar and engaging with the elongated slots that selectively align with each other;
multiple fastening holes formed separately through the rib, and each fastening hole in the rib aligning with one transverse fastening hole in the panel; and
multiple fasteners, and each fastener mounted through a corresponding transverse fastening hole of a corresponding panel and mounted securely in a corresponding fastening hole in the rib.

17. The portable device as claimed in claim 13, wherein
each panel has
a working side, wherein when the portable device is closed, the working sides of the panels face each other; and
two outer sides parallel to each other wherein each outer side of one of the panels aligns with one outer side of the other one of the panels 10A when the portable device is opened at 180 degrees, and each outer side having
an elongated slot formed on the outer side; and
multiple transverse fastening holes formed separately on the outer side and corresponding to and communicating with the elongated slot; and
the linking unit of each one of the at least one hinge comprises
a flexible bar having
an elongated hole formed longitudinally through the flexible bar and receiving the flexible tube;
a rib formed on a side of the flexible bar and engaging with the elongated slots that selectively align with each other;
multiple fastening holes formed separately through the rib, and each fastening hole in the rib aligning with one transverse fastening hole in the panel; and
multiple fasteners, and each fastener mounted through a corresponding transverse fastening hole of a corresponding panel and mounted securely in a corresponding fastening hole in the rib.

18. A portable device with at least one hinge as claimed in claim 2, wherein the portable device comprises two panels, and the linking unit of the at least one hinge is respectively attached securely to the panels.

19. The portable device as claimed in claim 18, wherein
each panel has
a working side, wherein when the portable device is closed, the working sides of the panels face each other;
a pivoting side, wherein when the portable device is opened at 180 degrees, the pivoting sides of the panels face each other;
multiple transverse fastening holes formed separately on the working side of each panel; and
multiple longitudinal receiving holes formed separately on the pivoting side of each panel, and each longitudinal receiving hole communicating with and corresponding to one transverse fastening hole; and
the linking unit of each one of the at least one hinge comprises
two sleeves respectively mounted securely around two ends of the flexible tube, and each sleeve mounted through a corresponding longitudinal receiving hole of a corresponding panel; and
two fasteners, and each fastener mounted through a corresponding transverse fastening hole of a corresponding panel and mounted securely in a corresponding sleeve.

20. The portable device as claimed in claim 18, wherein
each panel has
a working side, wherein when the portable device is closed, the working sides of the panels face each other; and
two outer sides parallel to each other wherein each outer side of one of the panels aligns with one outer side of the other one of the panels 10A when the portable device is opened at 180 degrees, and each outer side having
an elongated slot formed on the outer side; and
multiple transverse fastening holes formed separately on the outer side and corresponding to and communicating with the elongated slot; and
the linking unit of each one of the at least one hinge comprises
a flexible bar having
an elongated hole formed longitudinally through the flexible bar and receiving the flexible tube;
a rib formed on a side of the flexible bar and engaging with the elongated slots that selectively align with each other;
multiple fastening holes formed separately through the rib, and each fastening hole in the rib aligning with one transverse fastening hole in the panel; and
multiple fasteners, and each fastener mounted through a corresponding transverse fastening hole of a corresponding panel and mounted securely in a corresponding fastening hole in the rib.
